(19) United States
(12) Patent Application Publication
(10) Pub. No.: US 2013/0112392 A1
(43) Pub. Date: May 9, 2013

(54) TEMPERATURE CONTROL IN AIR COOLED HEAT EXCHANGERS

(71) Applicant: Cenovus Energy Inc., Calgary (CA)

(72) Inventor: Milosz Konrad Karpinski, Airdrie (CA)

(73) Assignee: Cenovus Energy Inc., Calgary (CA)

(21) Appl. No.: 13/660,858

(22) Filed: Oct. 25, 2012

Related U.S. Application Data
(60) Provisional application No. 61/551,377, filed on Oct. 25, 2011.

(30) Foreign Application Priority Data
Oct. 25, 2011 (CA) 2756302

(51) Int. Cl. G05D 23/13

(52) U.S. Cl. 165/300

(57) ABSTRACT

A method, apparatus and system for temperature control of a fluid in an air cooled heat exchanger (ACHE). Certain embodiments may involve measuring a discharge fluid temperature of a fluid discharged from the ACHE, reducing a fan speed and at least partially closing an air intake and/or an air exhaust of the ACHE when the discharge fluid temperature meets a discharge fluid temperature criterion to reduce cooling of the fluid in a tube bundle of the ACHE, measuring a plenum chamber air temperature, and injecting heated air proximate the tube bundle when the plenum chamber air temperature meets a plenum air temperature criterion to avoid overcooling of the tube bundle fluid.

### CROSS-REFERENCES TO RELATED APPLICATIONS

This application claims priority from U.S. App. No. 61/551,377 and Canadian Patent Application No. 2,756,302, both filed Oct. 25, 2011, the disclosures of which are incorporated herein by reference in their entirety.

### BACKGROUND OF THE INVENTION

1. Field of Invention

This invention relates generally to temperature control, and more particularly, to process fluid temperature control in air cooled heat exchangers (ACHEs).

2. Description of Related Art

Air-cooled heat exchangers (ACHEs) are large semi-enclosed structures used to cool fluids in industrial processes requiring dissipation of large quantities of heat, especially in cases where water-based cooling is not available or practical. ACHEs are configured to air-cool a tube bundle containing a process fluid by using one or more fans to either force or induce ambient air to flow evenly, directed by a plenum chamber, through the tube bundle. Air passing in and through the tube bundle absorbs at least some heat from the tube walls and thus from the process fluid carried within the tube bundle. The heated air is then normally expelled into the atmosphere.

ACHEs are designed to be very efficient at exchanging and rejecting heat. While this is a positive feature for cooling performance in warm weather, there may be undesirable freezing, gelling or other viscosity problems during cold weather, especially where there is an upstream plant upset, power failure or other event leading to a “no flow” condition, for example. When the flow of hot process fluid to the ACHEs ceases, and the ambient temperature outside is sufficiently cold, the tube bundle inside can cool off very quickly. In extreme cases, the freezing of fluids could cause equipment damage such as ruptured pipes. Some heterogeneous liquids in particular, e.g., some water-bearing emulsions, may have portions susceptible to spot freezing near 0° C.

In cold weather, these kinds of problems may occur even in the absence of a catastrophic or unexpected event. For example, it is sometimes necessary to take an ACHE unit offline, for example, to perform scheduled maintenance or other repair work. Ordinarily, to do this during cold weather, the flow of hot process fluid to the unit must be stopped. However, once the flow of hot process fluid is stopped, there is no additional heat input which may cause the temperature of the processed fluid in the tube bundle to decrease quickly.

One winterization strategy to address the above concerns has been to embed heated glycol or steam coils in the plenum area near an ACHEs tube bundle. The ACHEs large fans are turned to pass air over the coils. As the large fans of the ACHE unit turn, they draw cold ambient air inside the ACHE and cause it to be preheated as it is drawn over the heated coils prior to its contact with the tube bundle. While such an approach mitigates some of the problems listed above, it has limitations as well.

In the case of a glycol winterization strategy, it is typical to provide a large glycol boiler, pumps, and other infrastructure. During cold weather, it is necessary to keep the glycol hot on an ongoing basis in order to be prepared for events such as an unexpected plant upset or a no flow condition. This incurs fuel costs regardless of whether one actually needs to use the glycol heating system. In other words, there are ongoing operational costs even in the absence of a plant upset or no flow condition. Also, the capital costs of a glycol boiler heating system are significant due to the infrastructure required. In some locations such a system may not be available or contemplated.

Preheating ambient air by drawing it over heated glycol coils using large fans is a somewhat slow and energy-inefficient method, and in any event, it may be impossible or undesirable at times to run the large fans in the ACHE units. For example, if personnel need to carry out maintenance or repair work within the ACHE, it may be undesirable to operate the large fans. In such circumstances, the ACHE must be taken offline prior to the maintenance or repair work being performed, by first draining all the tubes in the ACHE to avoid freezing problems. Restarting the ACHE after a shutdown may also be difficult in cold conditions.

### SUMMARY OF THE INVENTION

Embodiments of the invention are hereby disclosed that may address the above and other limitations in the art. Such embodiments may include an inventive air cooled heat exchanger and control system configured to use heated air from an associated remote air handling unit (AHU). The following is a non-exhaustive list of a few situations in which at least certain embodiments may be useful:

1. Embodiments of the invention may protect fluids in an ACHE from freezing, gelling or other undesirable changes in viscosity even at very low temperatures (e.g., winter conditions). For example, when the ambient temperature drops below zero, water-bearing fluid in the ACHE may be kept from spot freezing by injecting heated air from a remote source to displace cold air surrounding the tube bundle carrying the fluid through the ACHE.

2. Embodiments of the invention may be applicable to treating fluids in oil recovery operations, for example, at steam-assisted gravity drainage (SAGD) or cyclic steam stimulation (CSS) sites. For example, in some CSS operations, well pad operation may use casing gas compressors or vapor recovery units (VRUs) that involve fluid recycling through an air cooled heat exchanger. While in the summer the ambient temperature is high enough to keep fluids from freezing, in the winter this is not the case.

3. When an ACHE system must be shut down (e.g., for repair or maintenance work), the flow of process fluid to the unit must be stopped. In winter or in low ambient temperature conditions, problems can arise quickly because once the flow of hot fluid is stopped, there is no additional heat input, which can result in a rapid decrease in the temperature of the fluid in the tubes of the ACHE. Some embodiments of the invention may facilitate the draining of fluids from an ACHE in conditions that would otherwise result in the fluids freezing or gelling. In some cases, embodiments of the invention may make it possible to avoid draining the ACHE altogether to conduct a repair.

4. In some cases where an ACHE has been shut down, embodiments of the present invention may help to quickly restart the ACHE in colder conditions.

5. Embodiments of the invention may help to avoid freezing problems and ACHE equipment damage in the case of an unexpected fluid flow stoppage, for example, a “no-flow” condition caused by a power failure or plant upset.

6. More generally, embodiments of the present invention may be applicable to any cold temperature location using air cooled heat exchangers where, for example, a glycol coil heating system is not in place or is not planned. Embodiments of the invention may have lower capital costs and operating costs than corresponding glycol coil heating systems suitable for the same conditions.

In addition to the above advantages during cold weather operation, some of the embodiments disclosed may alternatively, or in addition, be used to assist and supplement the air-cooling operation of the ACHEs during very warm weather. In such embodiments, the control system is configured to inject cooled air from the remote air handling unit (AHU) into or proximate the plenum area to lower the average temperature of air contacting the air tube bundle and thus increase the rate of heat exchange of the process fluid with surrounding air, relative to the rate of heat exchange when using only ambient-temperature air for cooling.

In accordance with one aspect of the invention there is provided a method of temperature control in an air cooled heat exchanger including an air intake, an air exhaust, a tube bundle for carrying a process fluid to be cooled and disposed between the air intake and the air exhaust, at least one fan operable to create an airflow from the air intake through the tube bundle to the air exhaust, and a plenum chamber for directing the airflow between the at least one fan and the tube bundle. The method involves measuring a discharge fluid temperature representing a temperature associated with a cooled process fluid product discharged from the tube bundle and in response to the discharge fluid temperature falling to a first temperature, reducing a fan speed of the at least one fan to reduce cooling of the tube bundle. The method further involves, in response to the discharge fluid temperature falling to a second temperature lower than the first temperature, at least partially closing at least one of the air intake and the air exhaust to further reduce cooling of the tube bundle. The method further involves measuring a plenum chamber air temperature representing a temperature of air proximate the tube bundle. The method further involves, in response to the plenum chamber air temperature falling below a minimum plenum chamber air temperature threshold, causing heated air received from an air handling unit to be injected into the air cooled heat exchanger to displace at least some cold air from within the air cooled heat exchanger, to increase the temperature of the air proximate the tube bundle.

The air handling unit may be external to the air cooled heat exchanger and the heated air may be received into the air cooled heat exchanger from at least one external conduit interconnecting the air handling unit and the air cooled heat exchanger.

The method may involve injecting the heated air received from the at least one external conduit into the air cooled heat exchanger via at least one internal conduit in communication with the at least one external conduit and having at least one discharge opening for heated air injection.

The air handling unit may include a fuel-burning furnace.

Causing heated air to be injected may further involve discharging the heated air at a discharge location proximate a fan ring associated with the at least one fan.

Discharging the heated air proximate the fan ring may involve discharging the heated air at a location horizontally proximate at least one power delivery mechanism for the at least one fan.

The at least one internal conduit may have a distal discharge portion having a longitudinal axis parallel to an axis of rotation of the at least one fan.

The at least one internal conduit may have a horizontal cross sectional area of no more than about 4 square feet.

The method may involve discharging the heated air through at least one nozzle in communication with the at least one internal conduit and configured to direct the heated air toward the tube bundle.

The method may involve discharging the heated air proximate the tube bundle.

The air handling unit may include an industrial building heating system configured to produce heated air in a temperature range suitable for injection into buildings inhabited by humans.

The air handling unit may generate a heated air stream having a temperature of about 40 degrees C.

The method may involve, in response to the plenum chamber air temperature falling below a recirculation activation plenum temperature threshold, causing air to be recirculated within the air cooled heat exchanger.

The method may involve causing at least one internal recirculation louver to open to facilitate air recirculation within the air cooled heat exchanger.

The method may involve, in response to the plenum chamber air temperature exceeding a recirculation deactivation plenum temperature threshold, ceasing internal recirculation of air within the air cooled heat exchanger.

The method may involve switching to a backup power system in response to detection of a main power system outage.

At least partially closing at least one of the air intake and the air exhaust may involve actuating at least one set of louvers to close, and the method may further involve using power from the backup power system to enable the at least one set of louvers to close.

The method may involve using power from the backup power system to activate the air handling unit.

Measuring the discharge fluid temperature may involve measuring a fluid temperature associated with a header of an individual air cooled heat exchanger.

Measuring the discharge fluid temperature may involve measuring a fluid product temperature associated with a common header of a bank of air cooled heat exchangers.

The air handling unit may include a Heating Ventilation and Air Conditioning (HVAC) unit, and the method may further involve causing the air handing unit to deliver cooled air for injection into the air cooled heat exchanger to supplement fan-based cooling in the air cooled heat exchanger.

The air handling unit may involve an HVAC unit, and the method may further involve causing the air handing unit to deliver cooled air for injection into the air cooled heat exchanger to supplement fan-based cooling in the air cooled heat exchanger in response to the plenum chamber air temperature exceeding a forced air cooling plenum air temperature threshold.

The method may involve disabling the air handing unit from supplying heated air in response to the plenum chamber air temperature exceeding a maximum forced air heating temperature threshold.

The method may involve measuring the ambient air temperature, wherein heated air from the air handling unit is injected into the air cooled heat exchanger only if the ambient temperature falls below a minimum permissible ambient air temperature threshold.

The method may involve, in response to detecting a no flow condition for the process fluid, causing heated air to be injected from the air handling unit into the air cooled heat exchanger.

The method may involve, in response to detecting a louver malfunction condition, causing heated air to be injected from the air handling unit into the air cooled heat exchanger if the ambient air temperature falls below a minimum permissible ambient air temperature threshold.

The method may involve, in response to the plenum chamber air temperature falling below the minimum plenum chamber air temperature threshold, turning off the at least one fan.

The method may involve, in response to the plenum chamber air temperature falling below the minimum plenum chamber air temperature threshold, closing the air intake and the air exhaust.

The method may involve conducting maintenance work within the air cooled heat exchange unit without draining the tube bundle, notwithstanding that an ambient temperature outside the air cooled heat exchange is sufficiently cold to create a freezing risk for the process fluid.

In accordance with another aspect of the invention there is provided a computer-readable medium storing instructions for directing a processor circuit to execute any one of the above methods.

In accordance with another aspect of the invention there is provided a system for controlling the temperature of a process fluid. The system includes an air cooled heat exchanger including air intake provisions, air exhaust provisions, process fluid heat radiation provisions for radiating process fluid heat to surrounding air, and air moving provisions for moving air from the air intake provisions, through the process fluid heat radiation provisions, to the air exhaust provisions, and a plenum for directing the airflow between the air moving provisions and the process fluid heat radiation provisions. The system further includes discharge fluid temperature measurement provisions for measuring a discharge fluid temperature representing a temperature associated with a cooled process fluid product discharged from the air cooled heat exchanger, and fan speed control provisions for controlling the fan speed to a reduced speed in response to the discharge fluid temperature falling to a first temperature. The system further includes air intake control provisions and air exhaust control provisions for respectively controlling the air intake provisions and the air exhaust provisions from an open position to a closed position in response to the discharge fluid temperature falling to a second temperature below the first temperature. The system further includes plenum air temperature measurement provisions for measuring an air temperature in the plenum. The system further includes heated air stream generation provisions, located external to the air cooled heat exchanger, for generating a stream of heated air, and heated air stream injection provisions for injecting the stream of heated air from the heated air stream generation provisions into the air cooled heat exchanger. The system further includes heated air stream control provisions for causing the heated air stream generation provisions to inject the stream of heated air into the air cooled heat exchanger via the heated air stream injection provisions in response to the plenum air temperature falling below a minimum plenum chamber air temperature threshold, whereby at least some cold air is displaced by the stream of heated air from within the air cooled heat exchanger and at least some heat is imparted to air proximate the process fluid heat radiation provisions.

In accordance with another aspect of the invention there is provided an air cooled heat exchanger system. The system includes an air cooled heat exchanger including an air intake, an air exhaust, a tube bundle carrying a process fluid to be cooled and disposed between the air intake and the air exhaust, at least one fan operable to create an airflow from the air intake through the tube bundle to the air exhaust, and a plenum chamber for directing the airflow between the at least one fan and the tube bundle, the air cooled heat exchanger having an external air opening and an internal conduit in communication with the external air opening and operable to inject heated air received from the external air opening into the air cooled heat exchanger to displace at least some cold air therefrom. The system further includes a furnace operable to generate a heated air stream, the furnace being located externally to the air cooled heat exchanger, the furnace output being in communication with the external air opening. The system further includes a control system operably configured to: reduce a fan speed associated with the at least one fan of the air cooled heat exchanger in response to receiving a sensor measurement signal indicating that at least one discharge fluid temperature has fallen below a first temperature, close the external louvers of the air cooled heat exchanger in response to receiving a sensor measurement signal indicating that the at least one discharge fluid temperature has fallen below a second temperature, lower than the first temperature, and enable the air furnace to produce heated air for injection into the air cooled heat exchanger to displace at least some cold air from the air cooled heat exchanger and to impart heat to at least some cooler air proximate the tube bundle, in response to receiving a sensor measurement signal indicating that the plenum temperature has fallen below a minimum plenum air temperature threshold.

In accordance with another aspect of the invention there is provided an air cooled heat exchanger apparatus for facilitating temperature control of a process fluid. The apparatus includes a selectively sealable enclosure having an air intake and an air exhaust, the air intake including a set of air intake louvers, the air exhaust including a set of air exhaust louvers. The apparatus further includes at least one fan operable to cause a cooling airflow to flow along an airflow path from the air intake to the air exhaust. The apparatus further includes a tube bundle comprising a plurality of spaced apart tubes operable to carry the process fluid, the tube bundle being disposed in the airflow path between the air intake and the air exhaust. The enclosure further includes a forced air injection intake configured to receive a forced air stream from a location external to the enclosure to pressurize the enclosure when the air intake louvers and air exhaust louvers are closed, whereby at least some of the air within the enclosure is displaced to a location external to the enclosure. For example, the forced air injection intake may receive heated air from an external air handling unit including a furnace and operable to inject the heated air into the enclosure to displace at least some cold air from within the apparatus, to increase the temperature of the air proximate the tube bundle.

The apparatus further may include at least one internal conduit in communication with the forced air injection intake. The at least one internal conduit may have a distal discharge portion operable to discharge the forced air stream in at least one discharge location within the enclosure.

The distal discharge portion may be configured to discharge the forced air stream proximate a fan ring associated with the at least one fan.

The distal discharge portion may be configured to discharge the forced air stream proximate the tube bundle.

The distal discharge portion may have a longitudinal axis parallel to an axis of rotation of the at least one fan.

The at least one internal conduit may have a horizontal cross sectional area of no more than about 2% of the total circular section area circumscribed by the fan ring.

The distal discharge portion may include at least one nozzle configured to direct discharge of the forced air stream toward the tube bundle.

In accordance with another aspect of the invention there is provided a method of temperature control of a process fluid in a tube bundle of an air cooled heat exchanger (ACHE). The method involves (a) reducing a fan speed and at least partially closing an air intake and an air exhaust of the ACHE in response to a discharge fluid temperature falling below a first temperature threshold, to reduce cooling of fluid in the tube bundle. The method further involves (b) causing heated air received from an external air handling unit to be injected into the ACHE to displace cold air therefrom and to induce heating of fluid in the tube bundle, in response to a plenum chamber air temperature falling below a second temperature threshold.

The method may involve causing cooled air received from the external air handling unit to be injected into the ACHE to displace at least some heated air therefrom to induce cooling of fluid in the tube bundle, in response to the plenum chamber air temperature exceeding a forced air cooling temperature threshold.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a system for process fluid temperature control comprising a plurality of air cooled heat exchange units (ACHEs) cooperating with a plurality of air handing units (AHUs) and a control system according to one embodiment of the invention;

FIG. 2 is a simplified top plan view of one embodiment of an air cooled heat exchange unit having two cooling bays, each bay having two fans, the air cooled heat exchange unit being in communication with an external conduit air intake for receiving an airstream from an indirect gas fired make-up air (MUA) unit or furnace and having an internal air injection conduit operable to facilitate injection of the received airstream proximate a fan ring;

FIG. 3 is a side elevation view of the air cooled heat exchange unit shown in FIG. 2, with the view taken along lines III-III;

FIG. 4 is a simplified partial cross-section end view of one bay of the air cooled heat exchange unit of FIG. 2 taken along lines IV-IV;

FIG. 5 is a side elevation view of an air cooled heat exchange unit according to a further embodiment configured to facilitate injection of an airstream into the plenum via a perforation in a plenum wall;

FIG. 6 is a simplified partial cross-section end view of one bay of the air cooled heat exchange unit of FIG. 5;

FIG. 7 is a side elevation view of an air cooled heat exchange unit according to a yet further embodiment configured to facilitate injection of an airstream into the plenum through a perforation in a plenum floor internal to the air cooled heat exchange unit;

FIG. 8 is a simplified partial cross-section view of one bay of the air cooled heat exchange unit of FIG. 7;

FIG. 9 is a simplified partial cut away perspective view of an air cooled heat exchange unit having a recirculation bay and operating in recirculation mode according to one embodiment;

FIGS. 10A-C are side views of a variety of embodiments of a distal end discharge portion of an airflow delivery conduit such as a duct;

FIG. 11 is a schematic diagram of an illustrative control system according to one embodiment for controlling at least one air cooled heat exchange unit (ACHE) cooperating with at least one air handling unit (AHU) operable to cause forced air injection into the at least one air cooled heat exchange unit (ACHE);

FIG. 12 depicts an illustrative process fluid temperature control scenario in which the control system of FIG. 11 controls an air cooled heat exchange unit to respond to falling ambient temperatures, falling fluid output temperatures and falling plenum temperatures as a function of time, in one embodiment; and

FIG. 13 is a flowchart illustrating a control method of one embodiment of the present invention.

### DETAILED DESCRIPTION

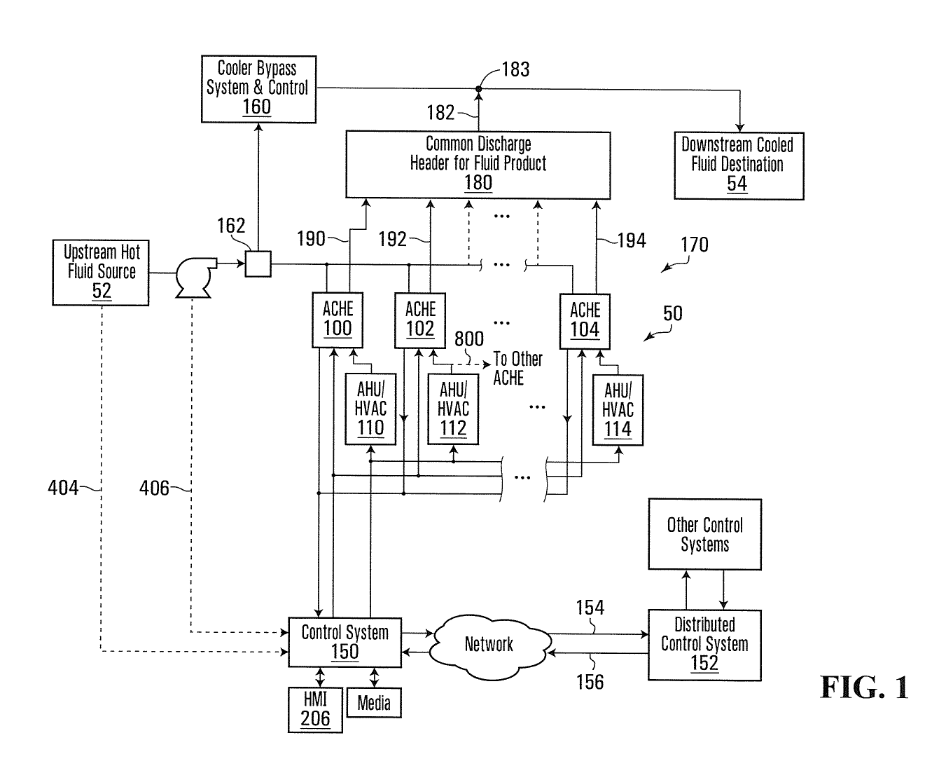

Referring to FIG. 1, a system for controlling a process fluid temperature according to one embodiment of the invention is shown generally at 50. The system is configured to try to maintain the temperature of process fluid within a desired temperature range. If the upstream input 52 to the system is a process fluid that is too hot for processing by equipment at a downstream fluid destination 54, the system 50 will pass at least some of the fluid stream through one or more cooling apparatuses such as 100, 102, 104, as described below. For example, certain kinds of oil product storage tanks have an upper temperature limit and cannot accept oil that exceeds this temperature limit. In this embodiment, each cooling apparatus 100, 102, 104 includes an air cooled heat exchanger (ACHE).

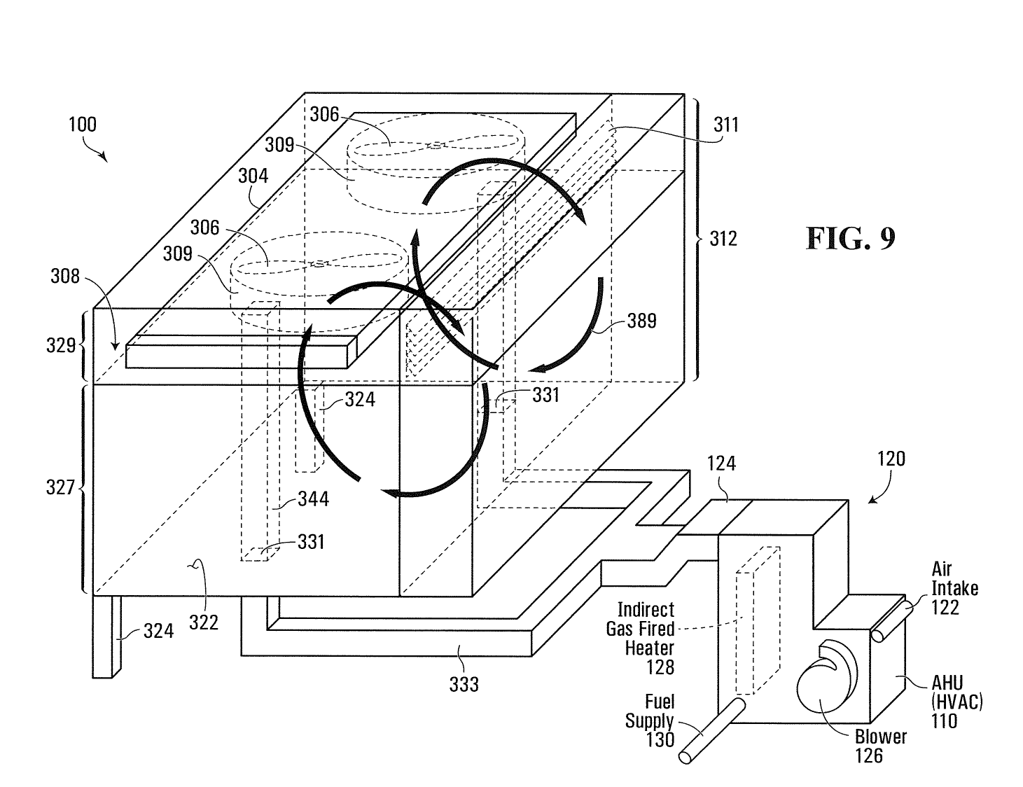

The system further includes a plurality of air handling units 110, 112, 114, operable to generate a stream of air for injection into at least one ACHE. The air handling units may include an HVAC system and/or an industrial or residential building heating system 120, for example, as shown in FIG. 9. In the latter case, the air handling units may include a furnace/heater, such as an indirect gas-fired furnace/heater 128, producing heated air having a temperature in a range suitable for use in buildings inhabited by humans, for example, heating air to a temperature of about 40° C. The air handling units include an air intake 122, an air exhaust 124, a blower 126 and a heater 128 or furnace that produces heat by burning fuel gas 130 such as natural gas or propane, for example. Alternatively, the furnace may be powered by any liquid fuel source or solid fuels such as coal or wood. In some embodiments, the air handling unit may be operable to produce only a stream of cooled air, or may be operable to selectively produce cooled or heated air, or a stream of air having a selectable temperature ranging from cold to hot.

The system also includes at least one control system 150 for controlling the cooling apparatus 100, 102, 104. The control system 150 may be a distributed control system or a centralized control system, and thus may include a network of computing devices or a single computing device such as a programmable general purpose computer or a programmable logical controller (PLC). In one embodiment, the control circuit may include an Allen Bradley Controllogix PLC performing control and data monitoring functions. In some embodiments, the control system associated with the cooling apparatus may communicate to a plant distributed control system (DCS) 152, for example, to a plant SCADA network via a fiber optic link for Ethernet communications. The control system 150 may communicate process variables and status information 154 to the distributed control system, and in turn, may receive control information and commands 156 from the distributed control system 152. The control system 150 may also be configured to receive information such as process variables and status from other control or measurement systems, either directly or via the DCS. In this embodiment, the control system 150 is operably configured to control the operation of a cooler bypass system 160, the plurality of air cooled heat exchangers 100, 102, 104, and the plurality of air handling units 110, 112, 114 in response to such inputs.

In the embodiment shown in FIG. 1, air cooled heat exchangers 100 are generally associated with one corresponding air handling unit 110 or HVAC, however, it will be appreciated that a single air handling unit or HVAC could be configured to service a plurality of air cooled heat exchangers (e.g., 800). Conversely, an individual air cooled heat exchanger 100 could be configured to receive air streams from more than one air handling unit or HVAC 110.

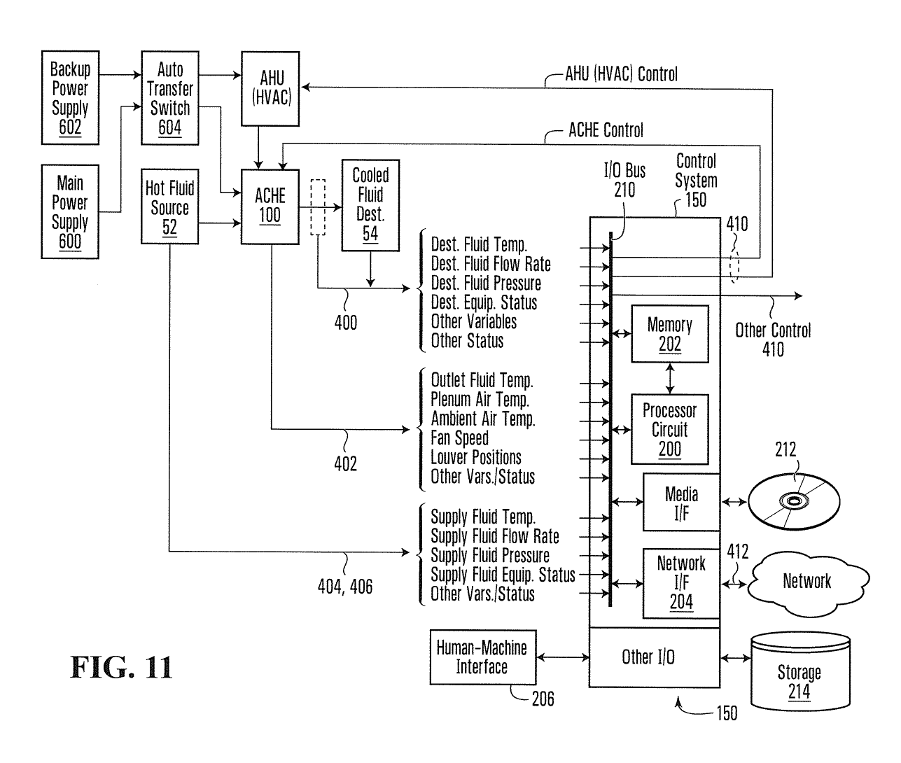

Referring to FIG. 11, a control system 150 in some embodiments may include a processor circuit 200 (e.g., one or more microprocessors, microcontrollers or other programmable digital logic devices) in data communication with at least one memory 202, network connection 204, and a human-machine interface (HMI) 206, for example, over a communication bus 210. It will be appreciated that the control methods described herein could be implemented equivalently by discrete component-based hardware, instead of by a processor circuit, or by a distributed control system in which different circuits independently make decisions about different control signals. Alternatively, modern control hardware or a general purpose computer may be programmed to execute the methods of the invention, for example, by software instructions implementing an interactive temperature controller, e.g., direct acting or reverse acting controllers or other types. The software instructions include codes for causing at least one microprocessor to execute the methods of the invention and may be stored in a computer readable memory 202 and/or on a computer readable medium 212 (e.g., a RAM, a ROM, a flash memory, a hard disk drive, or a removable optical disc).

The control system includes a human-machine interface (HMI) 206. The HMI may include at least one keypad, keyboard and/or pointing device for input, and an output system including a display, sound annunciator, and/or a set of indicator lights, for example. The control system may further include a permanent storage device 214 such as a flash memory or hard disk, and a media interface, such as a computer-readable medium storing instructions for directing the processor circuit to perform the control methods of the present embodiment. The control system takes a variety of inputs including, for example, process variables and status conditions 400, 402, 404, 406, 412, and produces a plurality of control or status outputs 410 including, but not limited to, those illustrated in the embodiment of FIG. 11. Control outputs of the system 150 may include radio or electrical signals 412 operable to cause other components of the overall system to perform certain actions.

The system of FIG. 1 includes a plurality of air cooled heat exchangers 100, 102, 104 arranged and controlled as one or more banks 170. For example, one set of heat exchangers may be controlled together as a bank using a first set of control parameters associated with process fluid originating from a first upstream heated fluid source, whereas a second set of heat exchangers may be controlled together as a bank using a second set of control parameters associated with process fluid originating from a second upstream heated fluid source 52. The heated fluid may be an oil-condensate mixture (dilbit), an oil and naphtha mixture (synbit), an oil and water emulsion, a gas/water mixture a gas/oil mixture, or a gas and gas liquids mixture, for example.

In a steam-assisted gravity drainage (SAGD) operation, for example, the first set of heat exchangers may process a first oil mixture such as synbit or dilbit and originating from a first phase of a SAGD project, whereas the second set of heat exchangers may process a second oil mixture of different composition and originating from a second phase of the SAGD project, the second oil mixture having different temperature control requirements than the first. The hot oil mixture or emulsion from each fluid source may be delivered to the cooling system with the aid of at least one booster pump.

The system shown in FIG. 1 also includes a cooler bypass system 160 which optionally allows some, all, or none of the hot oil mixture to be directed to the cooler bank, depending on the nature and temperature of the input fluid, the specific process requirements, and the actual conditions of the ACHE cooling.

Individual air cooled heat exchangers 100, 102, 104 may discharge cooled process fluid into a common discharge header 180, whereupon the individual outputs are mixed into a common output 182 carrying a cooled fluid product. The temperature of the cooled fluid product is measured and monitored carefully as it must be maintained within a temperature range acceptable for downstream process fluid destinations 54. As an alternative, the temperature of a cooled fluid product may instead be measured and monitored at outputs 190, 192, 194 of one or more of the individual air cooled heat exchangers. These temperature measurements are used as an input into the control system 150 to enable to control system to control the operation of the ACHE bypass system 160 and operation of the ACHE banks 170, including the operation of individual ACHE units 100, 102, 104, as will be described below.

In one embodiment, the control system 150 includes a direct acting (i.e., PV-SP) temperature controller operably configured to use a split range control strategy to control VFD fans and process louvers in the ACHE units as shown below in Table 1. As the outputs of the direct acting controllers increases from 0 to 50%, the process louvers will move from 0 to 100% open. As the direct acting controller further increases from 50 to 100%, the VFD fans will ramp up from a minimum speed of 30% to 100%. This method will initially allow ambient air to cool the process fluid, and if that is not enough, the fan motors will begin to ramp up to try to maintain the overall fluid discharge at a programmed target temperature, e.g., 35 degrees C.

TABLE 1
Split Range Control Algorithm For VFD Fans and Louvers

| Discharge Header | | |
|---|---|---|
| Temperature | | Cooler Fan |
| Controller Output | Process Louvers | VFD Speeds |
| 0% | 0% Open | 0% |
| 10% | 20% Open | 0% |
| 20% | 40% Open | 0% |
| 30% | 60% Open | 0% |
| 40% | 80% Open | 0% |
| 50% | 100% Open | 30% |
| 60% | 100% Open | 44% |
| 70% | 100% Open | 58% |
| 80% | 100% Open | 72% |
| 90% | 100% Open | 86% |
| 100% | 100% Open | 100% |

While, in this embodiment, the common header discharge 182 temperature measurements are used by the control system to set the VFD fan speeds and louver positions for all of the ACHE coolers in the system as described by Table 1, it will be appreciated that a different algorithm might be programmed into the control system for a different process fluid or a different set of ACHE infrastructure. The present invention is not limited to this specific algorithm.

In one embodiment, the common discharge header 182 fluid temperature is measured, and the control system 150 uses the measurements (e.g., 400) to determine whether it satisfies a set of programmed process parameters. For example, given a target output cooled fluid temperature of 35° C., the control system 150 monitors the discharge fluid temperature for conformance to the target temperature. In this embodiment, if the actual measured temperature of the process fluid at the common discharge 182 is 37° C. for more than five minutes, the control system 150 causes an additional air cooled heat exchange unit from the bank of ACHEs 170 to come online to help cool the overall heated fluid stream. If another five minutes elapses and the ACHE bank's overall fluid output temperature still exceeds the preset threshold (i.e., 37° C.), then the control system causes yet another air cooled heat exchange unit 100, 102 to come online, and so forth, until all the ACHE units available in the bank 170 are operating at full cooling capacity.

Conversely, in the same embodiment, if the actual fluid output temperature is found to be below a lower limit of a permissible band of temperatures, for example, lower than 33° Celsius, for more than a predetermined time, such as five minutes, the control system may send a signal to cause an operating air cooled heat exchanger (ACHE) unit turn off. Preferably, the ACHE unit taken offline is the last running unit. If the cooled fluid output temperature still does not rise sufficiently, the control system may continue to take subsequent ACHE units off-line. By the same token, if the control system detects overcooling of process fluid at the overall fluid output, the individual air cooled heat exchange units (e.g., 100, 102, 104) operating within the bank 170 may be controlled to reduce their respective fan speeds and/or to close their respective air intakes and/or air exhausts (e.g., close their side and top louvers, in one embodiment).

In some embodiments, the bypass system 160 for bypassing the bank of coolers 170 may include at least one bypass control valve 162 to allow the hot process fluid flow to bypass the air cooled heat exchangers 100, 102, 104 if required to address pressure drop concerns. For example, if one out of 10 coolers is off-line for maintenance, the bypass control valve may be set by the control system to allow 10% of the flow to bypass the cooler bank 170 in view of the cooler bank's reduced total cooling capacity. Process fluid that has been cooled by the cooler bank 170 may be mixed downstream at a junction 183 with hot process fluid that has bypassed the cooler bank.

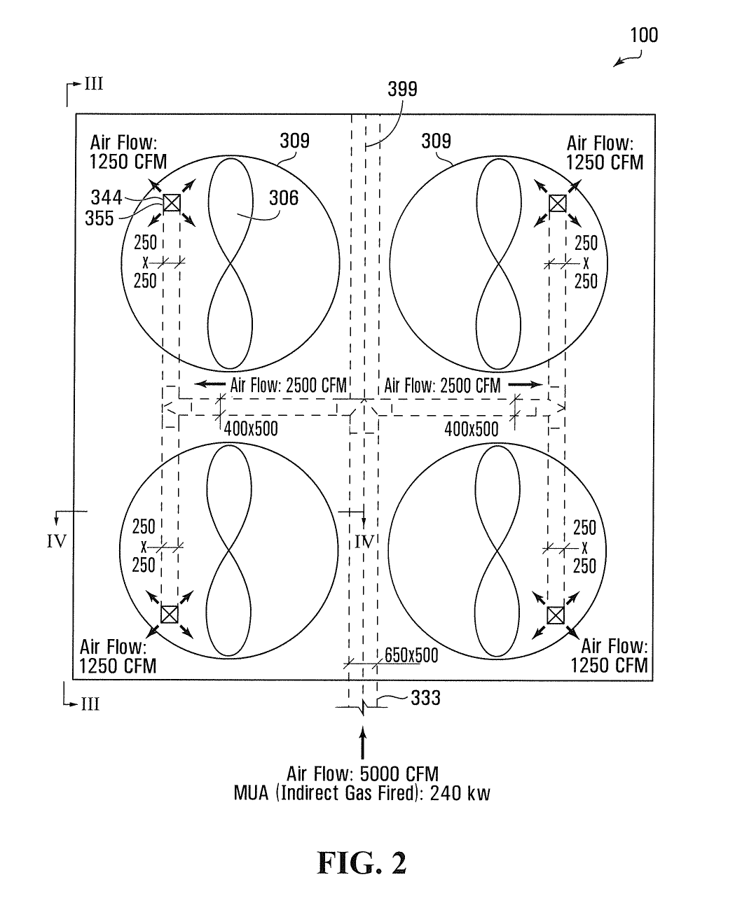

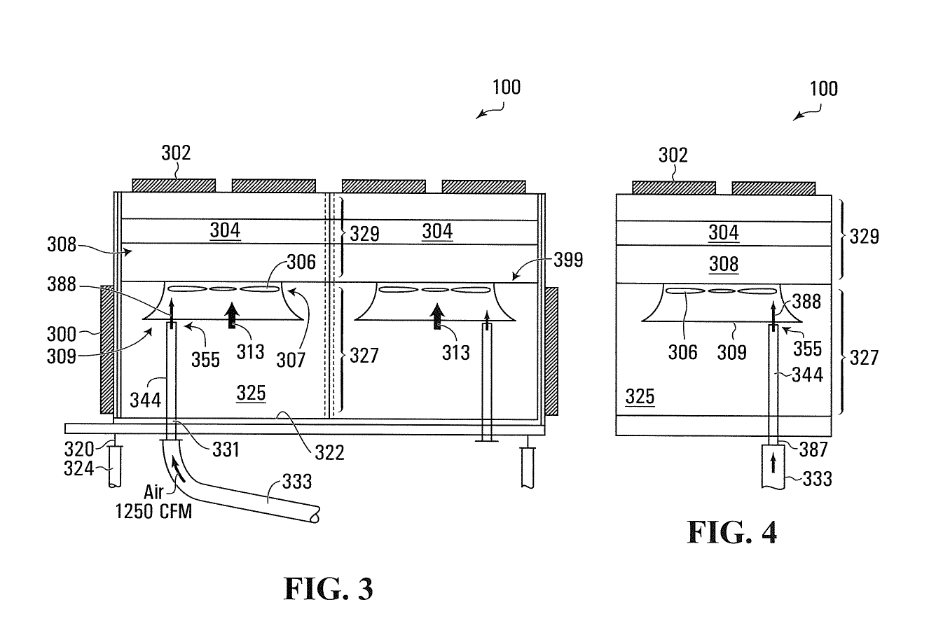

Referring now to FIGS. 2 to 4 and 9, an air cooled heat exchanger (ACHE) 100 of the forced air type is shown in accordance with one embodiment thereof. In general, as shown in FIG. 3, the air cooled heat exchanger includes an air intake 300, an air exhaust 302, a tube bundle 304 carrying a process fluid to be cooled and disposed between the air intake and the air exhaust, and at least one fan 306 operable to create an airflow or air stream proceeding from the air intake 300, through the tube bundle 304 (i.e., in between the spaces separating the plurality of tubes in the tube bundle) and to the air exhaust 302. The ACHE 100 also has a plenum chamber 308 for directing the airflow between the fan(s) 306 and the tube bundle 304.

In this embodiment, the air cooled heat exchanger 100 includes a support base 320, and a plurality of walls, including a floor 322, enclosing a box-like inner space 325, all supported by the support base. The base may include a plurality of legs 324. The inner space 325 is generally divided into two portions: a lower portion 327 and an upper portion 329. The at least one fan 306, and a fan power system infrastructure mounted on a corresponding fan support structure 307, may be located adjacent to or in the upper portion 329 of the inner space 325. Each fan is generally associated with a corresponding fan ring 309 surrounding the fan. The fan ring 309, which may be protected by a bird screen, is configured to direct air in an axial direction 313 while preventing or reducing undesirable turbulence, noise or recirculation of air. The upper portion 329 further includes the plenum chamber 308 above the fan(s) 306 for directing air between the fan(s) 306 and the tube bundle 304. Evenness of airflow in such an air cooled heat exchanger 100 is an important consideration and thus various airflow devices and structures (e.g., fan rings, plenum chambers, walls and the like) have been provided. Structures which interfere with airflow are generally undesirable within an air cooled heat exchanger because such structures could lead to uneven cooling of the process fluid in the tube bundle 304. In operation, the tube bundle 304 functions to radiate process fluid heat to the surrounding air.

In some embodiments, the plenum chamber 308 includes two plenum temperature averaging resistance temperature detector (RTD) temperature sensors, one at each end of the tube bundle 304, and disposed in a respective peripheral plenum end area. In this embodiment, the plenum temperature readings are calculated as an average of the two plenum temperature averaging RTDs. If one of these RTDs fails or is bypassed in response to a command entered from the HMI 206, an averaging relay will automatically select the functioning RTD and use its direct readings for control and shutdown purposes. If both RTDs fail, a system shutdown is initiated. Alternative temperature sensors and methods of measuring or averaging plenum chamber air temperature may be used in other embodiments.

In this embodiment, the air cooled heat exchanger (ACHE) 100 has an external air intake 331 in communication with an external air conduit 333 connected to an external AHU or HVAC 120, wherein the external air intake comprises an opening formed in the floor 322 of the ACHE (see FIG. 3).

Referring to FIGS. 2 and 3, the air cooled heat exchanger (ACHE) 100 further includes an internal conduit 344 in communication with the external air intake opening 331 and operable to inject a stream 388 of heated air (or cooled air, in some embodiments), received from the external air intake opening, into the air cooled heat exchanger to displace at least some air therefrom. The internal conduit 344 includes a distal end discharge portion 355 operable to inject the air stream received from the external air handling unit 110 into a particular portion of the air cooled heat exchanger 100. If the purpose is to provide additional heat to the inner space, heated air may be received from the external air handling unit 110 via the external air intake opening 331 and conveyed via the internal conduit 344 to cause at least some of the colder air already present within the inner space 325 of the air cooled heat exchanger 100 to be displaced from the enclosure by the ingress of the heated air. The internal air conduit 344 may protrude somewhat (e.g., 150 mm) through the floor 322 of the ACHE 100 to provide a flanged attachment point 387 to the external air conduit 333 (in this embodiment, an HVAC duct). The flanged connector portion 387 does not extend beyond the legs 324 of the ACHE unit 100 to ensure that the protruding ductwork or connector is not damaged during transportation or assembly of the ACHE unit.

FIG. 2 further illustrates an embodiment of a conduit or duct layout for two bays of an air cooled heat exchanger 100, the respective plenums of the two bays being separated by a plenum separation wall 399. In this embodiment, a large (e.g., 650×550 size) horizontal duct 333 is brought from an external or remote air handling unit 110 such as an HVAC and is extended horizontally underneath the air cooled heat exchange unit floor 322. In this embodiment, at two or more points, the large duct may be split into successively smaller horizontally extending ducts (e.g., 400×500 size), in order to provide a path for the forced air stream to be distributed to various points of the air cooled heat exchanger 100. The horizontal ducts are connected at a junction 345 to a vertically oriented, relatively small (e.g., 250×250 size) columnar duct 344 rising vertically from the floor 322 and terminating within a circular area circumscribed by the fan 306 and fan ring 309. To avoid airflow disruption, the distal discharge portion 355 of the internal conduit 344 may have a longitudinal axis parallel to an axis of rotation of the fan 306.

In FIG. 2, one upwardly extending internal conduit 344 is associated with each fan ring 309, however, it will be appreciated that in some embodiments only one of two fans associated with an ACHE bay may have its own corresponding internal conduit. In still other embodiments, a fan ring 309 may have a plurality of internal conduits rising below it to discharge the air stream. For example, each fan ring 309 could be associated with four individual duct columns, underlying four corners of the corresponding fan ring. If additional ducts are used, the diameter of individual ducts may be reduced.

In the present embodiment, the internal conduit 344 used to inject the heated air has been sized as small as possible while achieving the purpose of delivering sufficient heated air. To minimize interference with air flow in the ACHE, the allowable cross sectional area of the ducting needs to be determined in consultation with an ACHE designer to ensure that ACHE air flow area is not excessively reduced by improper ductwork or other equipment. The ACHE designer provides the required winterization heat duty to the HVAC designer. A representative heat duty is 500K-1 MM BTU/hr for winterization where the ACHE fans are not running, to 5 MM BTU/hr where the ACHE fans are running and a recirculation bay is in use. The difference in BTU/hr requirements is associated with the amount of leakage of air from the air cooler to the environment. Once the allowable cross sectional area of the ducting is determined, the designer will use standard HVAC industry calculations to size the air flow from the HVAC to deliver the required BTU's/hr to the ACHE, taking into account the pressure drop from the added ducting.

In the present embodiment, the fans are about 15 feet in diameter and thus they circumscribe a circular area of about 177 square feet. In order to avoid undue disruption to the air flow, the injection conduit was sized to be about 2 square feet, which is about 1% of the overall area circumscribed by the fan blade. In one embodiment, a suitable cross sectional area of the air injection conduit may be in the range of about 1 to about 4 square feet, and preferably should not exceed about 4 square feet (about 2% of the area). The air handling unit selected for use in this embodiment was sized to match the heat requirements of the ACHE unit in view of the duct size. In particular, a 240 kw HVAC was selected in order to supply a 40° C. airflow at a rate of 5000 CFM to each of two bays of the ACHE unit. The airflow is split to four separate points, each with an airflow of about 1250 CFM. In this embodiment, the conduits include externally insulated 2″ foil backed fiberglass with an aluminum foil vapor barrier, and clad with 20 gauge smooth aluminum liner.

The upper portion 329 of the inner space also includes the tube bundle 304, which includes a plurality of spaced apart tubes extending horizontally across the ACHE unit. The tubes generally have a relatively small diameter, for example, about 1 inch, in order to provide a large surface to volume ratio to facilitate heat exchange between the tubes and surrounding air. The tube bundle is bounded at its first and second ends by first and second headers.

The outer walls of the air cooled heat exchanger in this embodiment include selectively sealable air intake and air exhaust provisions, such as a selectively sealable air intake 300 comprising at least one set of intake louvers (or baffles or any equivalent structure capable of selectively opening and closing an airflow path). The upper portion 329 of the air cooled heat exchanger includes a selectively sealable air exhaust 302 comprising at least one set of exhaust louvers or baffles. Thus, the air intake 300 in this embodiment is implemented by one or more sets of side louvers, and the air exhaust 302 is implemented by one or more sets of top louvers. The louvers may be actuated by electric actuators or by pneumatic actuators, for example. The floor 322 in this embodiment is generally solid, whereas in other embodiments, the air intake for cooling operations may be through the floor, rather than through the sides.

FIG. 9 illustrates another optional feature which is present in some embodiments, namely, a recirculation bay 312 operable to selectively communicate with the plenum chamber 308 depending on the position of a set of internal recirculation louvers 311. In other words, the plenum area may contain a set of recirculation louvers 311 for recirculating air from the plenum chamber 308, via the recirculation bay 312, which acts as a duct, between the plenum chamber 308 and the bottom box 327, whereupon the recirculated air 389 may be drawn by the fan 306 from the bottom box 327 up into the plenum chamber 308. As mentioned above, smooth airflow within an air cooled heat exchanger is very important. Ordinarily, during cooling operation, recirculation of air is undesirable because the recirculated air tends to be warmer than ambient air and therefore is less effective in cooling the tube bundle 304.

However, in special circumstances, such as winter conditions, it may be desirable to intentionally facilitate recirculation of warmer air within the inner space. For example, in response to either a fluid product output temperature that is unacceptably low, or a plenum air temperature that is below a minimum plenum temperature threshold, the control system may cause some or all of the external louvers (i.e., the side air intake louvers and/or the top air exhaust louvers) to close partially or wholly. Once the flow of ambient air in and out of the inner space is restricted, whatever warmth is present in the inner space will tend to be conserved for a longer period of time before being dissipated into the atmosphere. To avoid having fluid in the tube bundle being subject to spot freezing or viscosity problems due to low temperatures, in such circumstances, the control system may be configured to open the recirculation louvers 311 to cause air drawn up by the at least one fan to recirculate in the manner illustrated in FIG. 9. The recirculation facilitates a more even temperature distribution and heat exchange across the entire tube bundle.

FIG. 9 also illustrates how the air cooled heat exchanger 100 may be connected via a network of ducts to an external air handling units 110, which may include an indirect gas-fired heater or furnace 128 burning fuel received from a fuel supply 130. The furnace includes an integrated blower or fan 126 operable to cause heated air from the AHU to be forcefully discharged into the network of conduits (e.g., 333) leading to the one or more internal conduits (e.g., 344) within the inner space of the air cooled heat exchanger 100 to inject the heated air therein. Injection of the heated air causes at least some of the colder air within the inner space to be displaced due to the slight pressurization of the inner space that occurs and the consequent leakage of air through the various louvers (louvers typically are not airtight).

Advantageously, the embodiment shown in FIGS. 2-4 and 9 is operable to inject a heated air stream in the vicinity of the fan ring 309 such that the heated air has a clear path to follow to rise to the tube bundle 304.

Preferably, the injection point for the heated air stream is the closest location to the tube bundle that allows the heated air to impart heat to the tube bundle 304. In the embodiment shown in FIG. 3, if the injection location was at a lower height, this would result in unnecessary heating of the large empty space located below the fan blades 306. In general, it is possible to locate the discharge location anywhere underneath the circle circumscribed by the fan ring. It will be appreciated that some areas underneath the fan ring may be obstructed by fan power delivery infrastructure such as motors, pulleys or gearboxes, for example. Consequently, it is possible to achieve a slightly higher injection point by offsetting the injection point from the fan drive system by horizontal displacement while still keeping the injection point lower than the fan blades 306.

Because hot air preferentially rises, a vertical temperature gradient will be formed across the inner space of the ACHE 100. However, the preferential heating of, and the preferential displacements of cold air in the vicinity of the tube bundle 304 is beneficial in that it allows for a greater amount of heating of the tube bundle to occur for a given amount of fuel. In other words, less fuel or energy overall is required to maintain the tube bundle 304 at a particular temperature, compared to a scenario in which the entire inner space of the air cooled heat exchanger 100 is heated to a relatively uniform temperature. The fact that cold air tends to fall to the bottom portion of the inner space in general does not negatively affect the heating of the tube bundle 304. If the discharge or injection point of the heated air was made lower, a correspondingly greater amount of heating would need to take place to maintain the tube bundle 304 at a particular temperature, thereby incurring extra fuel costs.

In the present embodiment, the control system 150 may be configured to cause the recirculation louvers 311 to open when a stream of heated air from the external air handling unit 110 is fed into the air cooled heat exchanger 100. Maintaining the recirculation louvers 311 open may facilitate displacing cold air from the plenum area more quickly, and to the degree that recirculation and natural convection cause some mixing and air movement in the plenum chamber area, this will likely result in more even air temperature distribution across the tube bundle 304.

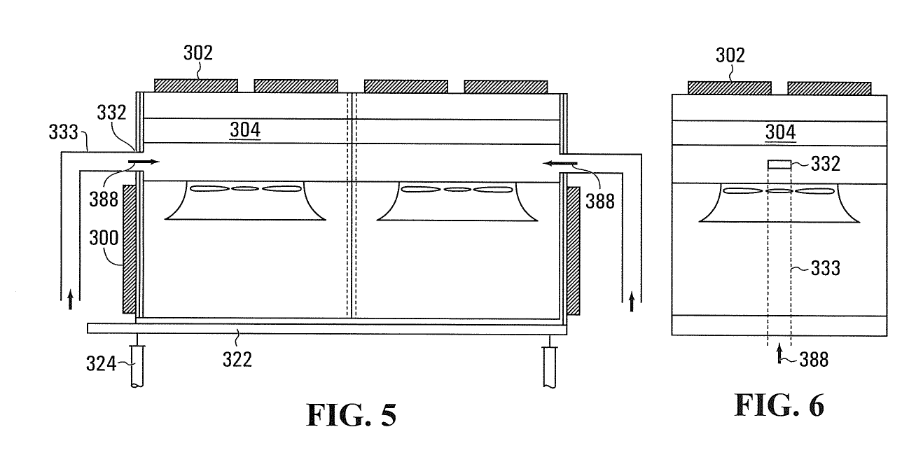

Referring to FIGS. 5 and 6, an alternative embodiment of the air cooled heat exchanger 100 is shown. In this embodiment, an external air conduit 333 or duct is brought up vertically alongside of a side wall of the air cooled heat exchanger 100, and then the conduit is passed through a perforation 332 in the plenum chamber 308 wall. In this embodiment, the conduit or ducting will terminate near the outer edge of the tube bundle 304. Two ducts could be installed, one on either end of the tube bundle to optimize air distribution, although a one duct arrangement is contemplated in some embodiments. This arrangement facilitates more directly injecting heated air 388 into the plenum chamber 308 area and thereby heating the tubes of the tube bundle 304.

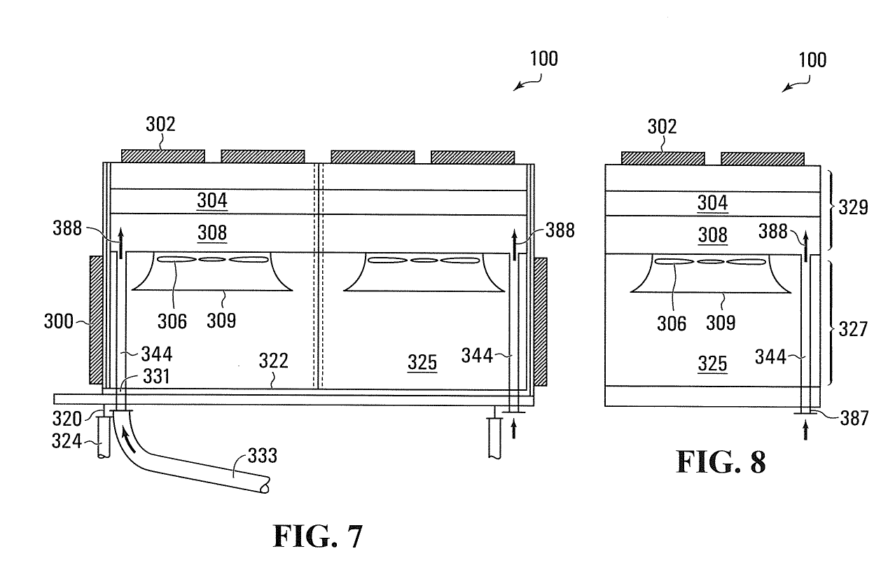

FIGS. 7 and 8 illustrate yet another alternative embodiment in which an internal conduit 344 connects through the floor 322 of the air cooled heat exchanger 100 to an external heated air flow source (such as an external hot air duct 333 from an external heater/furnace 128). The internal conduit 344 rises from the floor 322 vertically until it passes through a perforation 335 in a floor of the plenum chamber 308. In this embodiment, the internal conduit 344 or ducting will terminate near the outer edge of the tube bundle 304. Optionally, two such ducts could be installed, one at either end of the tube bundle 304, to optimize air distribution (as shown in FIG. 7). Once again, the close proximity of the discharge point to the tube bundle 304 facilitates creating advantageously even localized heating conditions in and around the tube bundle without necessitating an equal degree of heating of the rest of the inner space 325.

In all the embodiments which rely on heated air being forcibly injected into the air cooled heat exchanger, the convective movement of air itself helps to distribute heat relatively evenly to the various portions of the tube bundle. However, advantageously, these embodiments do not occupy very much space within the confines of the air cooled heat exchanger. Rather, the bulk of the equipment necessary to provide the heated air is located outside the air cooled heat exchanger, and therefore does not obstruct or significantly interfere with the designated airflow paths within the heat exchanger. While in such embodiments it may be necessary to add some internal air conduits, the overall impact of such conduits on the air flow characteristics inside the heat exchanger are fairly small. In addition, the present embodiments have minimized the footprint of such conduits and have arranged them to avoid significantly disrupting internal airflows of the air cooled heat exchanger. Consequently, in these embodiments, the conduits for injecting heated air do so at a point sufficiently close to the ACHE tube bundle to efficiently deliver the heated air when the ACHE fan is off, yet are also arranged to avoid significantly interfering with the flow of cooling air when the ACHE fan is on.

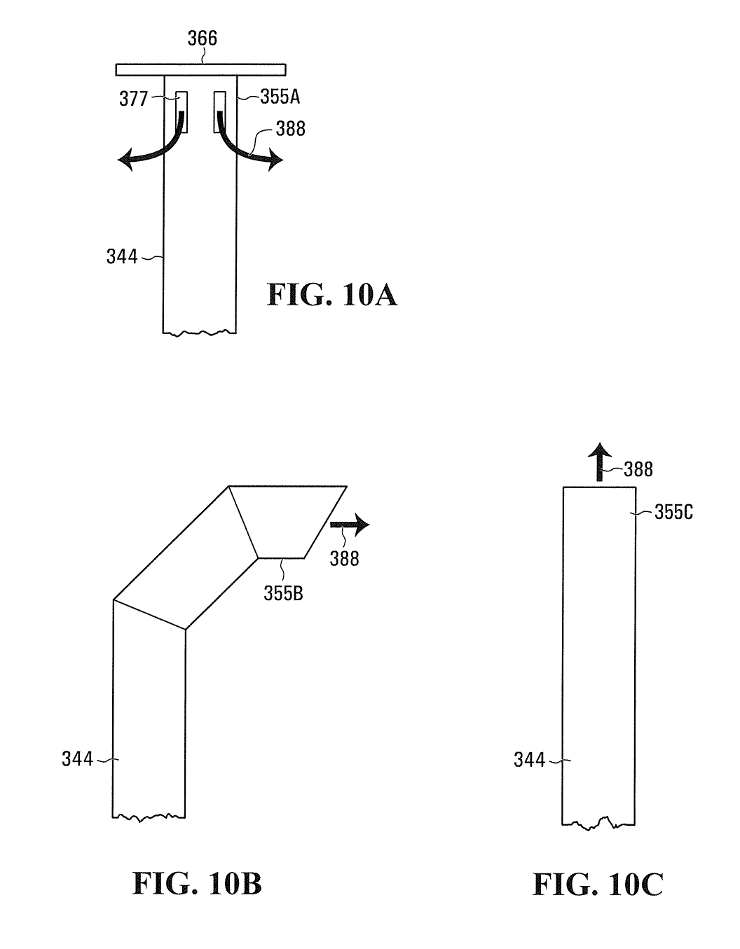

FIG. 10 illustrates several possible embodiments of a distal discharge portion 355 of the internal conduit 344. In particular, FIG. 10A shows a conduit termination 355A comprising a shield or “hat” 366 configured to prevent rain from falling into the conduit 344. This embodiment contains openings 377 cut in the sides of the ducting to allow the heated air 388 to exit the duct. FIG. 10B illustrates an embodiment of a distal discharge portion 355B having a directed nozzle for imparting a distinctive airflow direction to discharged heated air 388. In some embodiments, the airflow could be directed toward the tube bundle 304. While the illustrated embodiment shows that air is directed in only one direction, it will be appreciated that the discharge portion could be adapted to discharge air in more than one direction. FIG. 10C represents a straight conduit discharge portion 355C having a nozzle which simply discharges heated air 388 in a vertical direction. Alternatively, this embodiment could be modified to include one or more inner nozzles operatively configured to impart at least a partial non-vertical vector component to any discharged air.

Referring to FIG. 11, the exemplary control system 150 according to one embodiment is now further discussed. As shown in FIG. 11, the control system receives a plurality of process variables and other status information 400 regarding the fluid that is outputted toward the fluid destination. For example, the control system 150 in this embodiment is configured to monitor parameters including a destination fluid temperature, a destination fluid flow rate, a destination fluid pressure, a destination equipment status, as well as other variables and status information. The destination fluid temperature may be measured at a common discharge header associated with the aggregate combined fluid products of a bank of air cooled heat exchangers (see FIG. 1), or alternatively, one or more measurements may be made at the output of an individual air cooled heat exchanger. The process fluid temperature measured at a common discharge header is associated with and is reflective of an individual ACHE unit performance in the sense that the individual ACHE unit's output affects the average temperature of the fluid at the common discharge header and also because the individual ACHE unit's output should be very similar to the average performance of associated ACHE units in the same bank, assuming that the ACHE units are operating under similar conditions.

The control system 150 in this embodiment also receives a number of input variables 402 associated with one or more individual ACHE units, such as outlet fluid temperature, plenum air temperature, ambient air temperature, fan speed, louver positions, in addition to any other variables or status. Similarly, the control system 150 receives input signals (e.g., process variables and status 404, and pump status 406) from or associated with the hot fluid source(s) 52 that provide a feed into the air cooler heat exchanger system 50.

For example, the control system 150 receives and responds to variables 404 such as supply fluid temperature, supply fluid flow rate, a supply fluid pressure, supply fluid equipment status, and other variables and status. In this embodiment, blended oil metering may be performed, for example, the flow rate of an oil emulsion is calculated by taking the square root of the differential pressure and the wedge meter range.

Still referring to FIG. 11, another useful aspect associated with the control system 150 is disclosed, namely, a mechanism for dealing with a main power supply outage or failure. In the embodiment disclosed, an automatic transfer is provided via an automatic transfer switch 604 which seamlessly transfers power from the main power supply 600 to a backup power supply 602 (e.g., an emergency generator), in response to detection of a main power supply outage or failure.

The most critical aspects of the system 50, required to avoid catastrophic overcooling in this embodiment, are connected to the backup power supply 602. The control system 150, the pneumatic system for operating the louvers of the air cooled heat exchange units, and the air handling units—all these are connected to the backup power supply 602 to enable ongoing operation of the air cooled heat exchange units in the event of a main power outage or failure.

While some more power-hungry features (e.g., the large fans) in the heat exchange units are not connected to the backup power supply 602 in this embodiment, in other embodiments they too may be connected, at the cost of employing a somewhat larger backup power supply. It is unnecessary for the backup power system to be able to fulfil all normal power demands of, say, the large fans, as during emergency usage, it may only be necessary to run the fans at relatively slow speeds. In general, in the event of a plant upset or power failure, which results in a stoppage of hot fluid flow, the air handling units can provide sufficient heat to the air cooled heat exchanger(s) to prevent oil from solidifying in the piping while running on the backup power system.

As one example, upon the detection of a plant upset, power failure, or a no flow condition, power may be used from the backup power system to cause the external louvers of the air cooled heat exchanger to close to facilitate retaining heat inside, if the ambient air temperature is measured to be lower than a minimum ambient air temperature threshold such as 5° C. Once the external louvers are closed, the system may use the backup power supply to cause the air handling unit(s) to start up and to supply a stream of heated air to the air cooled heat exchanger(s), if the ambient air temperature is lower than a minimum ambient air temperature threshold or if the measured plenum temperature is lower than a minimum plenum air temperature threshold.

For some embodiments, a useful rule of thumb is to maintain the temperature of the air surrounding the tube bundle a predetermined amount (preferably approximately 10° C.) higher than the freeze point or pour point of the process fluid, i.e., the lowest temperature at which the process fluid will be able to flow relatively freely. Thus, if a certain dilbit or synbit oil blend is expected to begin experiencing flow problems at about −5° C., it may be desirable to maintain the plenum air temperature at about 5° C. In other embodiments, the minimum plenum air temperature threshold may be set in the control system 150 in a range of about 5° C. to about 10° C., or in a range of about 0° C. to about 15° C., for example.

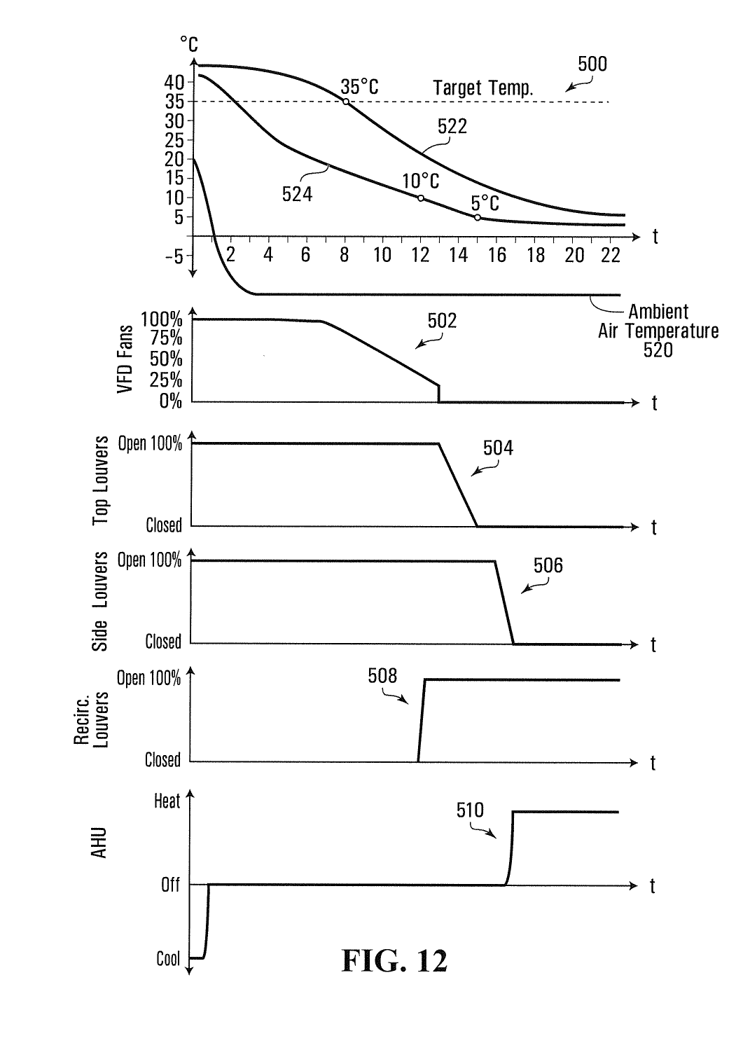

Referring now to FIG. 12, the operation of the control system 150 will be further described in the context of an illustrative control scenario in one embodiment. A temperature graph 500 shows the time progression of a discharged process fluid product temperature 522 relative to a plenum air temperature 524 and an outside ambient air temperature 520. At the beginning (time t=0), the discharged fluid product temperature 522 is measured at about 45° C., whereas the plenum air temperature 524 is somewhat lower. As shown, the scenario involves a sudden cold snap in which the ambient temperature 520 drops from 20° C. (t=0) to about −15° C. (t=3). As cold ambient air is drawn into the ACHE by the ACHE fan(s), it causes the plenum chamber air temperature 524 to begin to drop. This causes a greater amount of heat rejection by the tube bundle in the ACHE such that the discharged process fluid product temperature 522 decreases below a target temperature of 35° C.

A temperature controller in the control system 150 responds to the increasing error between the actual value and the target value for the output fluid temperature such that the control system in this embodiment begins to decrease the speed of the VFD fans in the ACHE starting at about time t=7 (see graph 502 in FIG. 12). The control system 150 is in effect responding to overcooling of the process fluid, as represented by the discharged process fluid product temperature 522, by sending control signals to cause the VFD fan speed to reduce. At t=13, the VFD fans are turned off.

Eventually, the control system 150 sends control signals to the ACHE unit to cause its internal recirculation louvers 311 to open (see graph 508), thus allowing air warmed by contact with the tube bundle 304 to be drawn down below the fan 306 and recirculated as the fan slowly turns. In this example, the internal recirculation of air slows but does not stop the decline in the measured plenum air temperature 524, and slows but does not stop the decline of the discharge process fluid product temperature 522. The control system turns off the VFD fans altogether at about time t=13. In this embodiment, the recirculation louvers 311 are left open, though in a different embodiment it may be desirable to close them when the fans are off.

At this point, the control system 150 detects that the measured discharged process fluid product temperature 522 is continuing to fall and thus sends control signals to the top louvers of the ACHE unit at about time t=13 (see graph 504) to begin to close the top louvers and thus to reduce further cooling of the tube bundle by natural convection. In response to temperatures continuing to fall, the control system 150 sends control signals to the ACHE unit to cause the side louvers to also close (see graph 506).

At about time t=17, the control system 150 detects that the measured plenum air temperature 524 has fallen below a minimum plenum air temperature threshold and also detects that the ambient temperature 520 is holding steady at a level that is well below a minimum ambient temperature threshold (e.g., 5° C.). In response to these measurements, as shown in graph 510, the control system 150 sends a signal to an AHU 110 comprising a heater to generate a stream of heated air for injection into the ACHE unit. Due to a slight pressurization of the ACHE's inner space caused by the injection of the heated air, at least some of the colder air within the ACHE is displaced to a location external to the ACHE, for example, by leakage of some colder air through the louvers (louvers typically are not airtight). Due to the displacement of colder air and the convection of heated air in the plenum chamber 308 and in the vicinity of the tube bundle 304, the rate of heat exchange of the tube bundle with surrounding air is reduced, such that the temperature of the discharged process fluid product 522 and the plenum air temperature 524 stabilize to an acceptable level, averting the risk of freezing or gelling of the process fluid, which would occur in this embodiment at about −5° C.

If the ambient temperature 520 rises such that the plenum air temperature 524 rises beyond a safe ambient temperature threshold stored in the control system 150, the control system will turn off the air handling unit 110. Similarly, as the process fluid temperature 522 continues to rise, the various other steps described above will generally occur in reverse order to increase the cooling capability of the ACHE.

In some embodiments, the various ACHE or AHU control steps may take place at different temperatures thresholds when temperatures are rising than when the process temperatures are falling. For example, in this embodiment, the recirculation louvers 311 were opened at 10° C. (at time t=12) when the plenum temperature was falling, but as the temperature rises, the control system may be programmed to wait for a higher plenum temperature threshold (e.g., 15° C.) to close the recirculation louvers 311. It will be appreciated that different processes may require different thresholds, or different combinations of thresholds. In other words, the recirculation deactivation plenum temperature threshold may be higher than the recirculation activation plenum temperature threshold.

FIG. 12 also illustrates an assistive cooling feature of some embodiments of the invention. As will be recalled, at time t=0 the discharge process fluid product temperature 522 was measured to be far in excess of a desired target temperature (e.g., 35 degrees C.), even though the fan speed of the ACHE was at a maximum and all louvers (except the recirculation louvers 311) were fully open. In other words, the ACHE unit was unable to provide sufficient cooling capacity to bring down the temperature of the discharged fluid. If the temperature of the discharged fluid 522 exceeds some maximum discharge fluid temperature, in this embodiment, as illustrated in graph 510 at t=0, the control system 150 sends a signal to the air handling unit 110 to begin to generate a stream of cooled air having a temperature lower than the ambient temperature 520 and to blow the cooled air into the ACHE 100. Because the air injected into the ACHE is cooled below ambient air temperature 520, this increases the heat exchange and heat rejection capabilities of the ACHE.

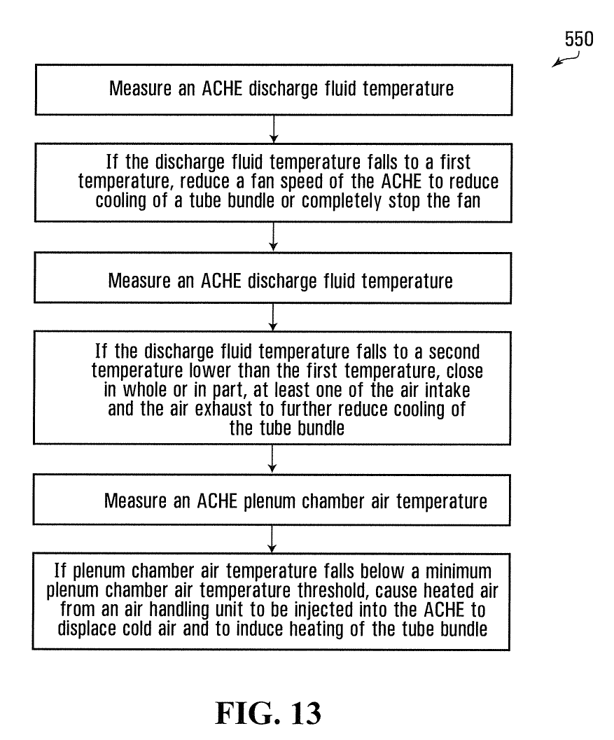

It should be understood that the above described temperature control method is not limited to the specific temperatures or ranges of temperatures recited above, and that the method steps may be undertaken in a different order in other embodiments. In some embodiments, the above described process fluid temperature control method may be generally characterized as follows (see flowchart 550 in FIG. 13):
(a) measuring a discharge fluid temperature representing a temperature associated with a cooled process fluid product discharged from the tube bundle of an air cooled heat exchanger (ACHE);
(b) in response to the discharge fluid temperature falling to a first temperature, reducing a fan speed of the at least one fan to reduce cooling of the tube bundle;
(c) in response to the discharge fluid temperature falling to a second temperature lower than the first temperature, at least partially closing at least one of the air intake and the air exhaust to further reduce cooling of the tube bundle;
(d) measuring a plenum chamber air temperature representing a temperature of air proximate the tube bundle; and
(e) in response to the plenum chamber air temperature falling below a minimum plenum chamber air temperature threshold, causing heated air received from an air handling unit (AHU) to be injected into the ACHE to displace cold air from within the ACHE and to cause an increase in temperature of air proximate the tube bundle.

### Other Embodiments

The heating function of the air handling unit (AHU) 110 may be invoked when a combination of conditions are met as programmed in the control system 150 by operational personnel. For example, in one embodiment the following permissives must be set in order for the air handling unit 110 to be enabled to supply heated air: (1) the large aerial cooler fans must not be running; (2) the louvers of the ACHE are closed; and (3) the upstream booster pumps pumping processed fluid to the heat exchanger must be offline. (If the booster pumps are not offline, presumably hot process fluid is going through the ACHE, and therefore heated air from the air handling unit is not needed.) In other embodiments, different conditions may be set up for running the AHU 110. In the case of a gas well, booster pumps may not be used as the gas is provided from the well under pressure. Nevertheless, a no-flow condition may occur if there is an upstream valve failure or other infrastructure problem. The control system may be programmed to turn on the AHU when there is no flow.

The AHU's heating function may be invoked either by the control system 150 in an automated mode of operation or in response to a command issued by operational personnel once all permissives have been met. A command may be issued manually through the HMI interface 206 or via a control network 156.

In one embodiment, if the plenum chamber air temperature 524 drops below a predetermined threshold, such as about 5° C., the permissives are set for the air handling system 110 to actuate its heated air injection function. Fluid discharge temperature 522 is potentially slower to react to ambient temperature 520 changes and thus by the time the fluid discharge temperature 522 begins to drop sufficiently, there may already be spot freezing elsewhere in the tube bundle. In addition, the fluid discharge temperature 522 is an average of many different tubes, and does not reflect localized temperature drops that may happen in some tubes of the tube bundle. Thus, the plenum chamber air temperature 524 is a better measure of whether the air handling unit (AHU) or HVAC ought to be blowing hot air.

In one embodiment, if the control system 150 detects that a no flow condition has occurred (e.g., the upstream fluid booster pumps have gone offline), the control system causes the ACHE fan(s) 306 to turn off in order to avoid overcooling. In one embodiment, the control system 150 also causes the external louvers 300, 302 to close and/or causes the air handling unit 110 to begin to inject heated air into the ACHE 100. In such an embodiment, although the plenum temperature 524 has not yet fallen to a critical level, the control strategy may be proactive in heating the tube bundle, if the ambient air temperature 520 is below a fluid-critical threshold. Thus, a proactive strategy is not needed in the summer when the ambient air temperature 520 is sufficiently high to avoid flow issues. A reactive strategy, in contrast, would wait for a critical temperature event to occur, such as an overly low plenum air temperature 524, for example, while the proactive approach may avoid encountering the critical temperature event in the first place. An analogous method may be applied in response to the control system 150 detecting a stuck louver condition: if the ambient air temperature 520 is below a fluid-critical threshold, a proactive forced air heating strategy is applied.

It should be appreciated that the various thresholds described may be conditioned on the type of fluid being processed, and need not be set to a fixed value (e.g., they can be set to be a function of a different process value).

In cases where it is a concern that the tube bundle 304 will not be heated evenly by the injection of heated air and convective mixing with existing air, it is possible to cause additional mixing of the air in the ACHE by causing the ACHE fans 306 to turn slowly. Of course, in such a case there will be less of a vertical temperature gradient in the inner space, and thus a greater amount of heat energy will be required to achieve a particular temperature inside.

While the above embodiments have been described with respect to a forced air-style ACHE, it will be appreciated that similar principles may be applied to embody the invention in an induced draft style ACHE. In an induced draft ACHE, the cooling airflow is drawn by a fan, first through the tubing string, after which it enters the plenum chamber, and from the plenum chamber reaches the fan itself, before being exhausted into the atmosphere. In a similar fashion to that described above, at least one conduit (e.g., a duct) in communication with an external air opening may rise from the floor of the ACHE to just below the tube bundle itself. A distal portion of the conduit proximate the tube bundle is operably configured to provide passage to heated air, optionally by using one or more nozzles to direct heated air along the tube bundle. In such a way, heated air received from the remote furnace is injected proximate the tube bundle. Because the induced draft style of air cooled heat exchanger locates much of its physical structure (including the plenum and the fan) above the tube bundle, given the tendency of hot air to rise, it will be necessary to heat a relatively larger portion of the inner volume of the induced draft type ACHE compared to the forced air type ACHE, which has its tube bundle located just below the highest point in the structure, a location to which hot air readily rises.

While specific embodiments of the invention have been described and illustrated, such embodiments should be considered illustrative of the invention only and not as limiting the invention as construed in accordance with the accompanying claims. It should also be appreciated that the embodiments disclosed herein are not mutually exclusive such that features of one embodiment may be combined with those of another embodiment to form still further embodiments falling within the scope of these claims.

1. A method of temperature control in an air cooled heat exchanger comprising an air intake, an air exhaust, a tube bundle for carrying a process fluid to be cooled and disposed between the air intake and the air exhaust, at least one fan operable to create an airflow from the air intake through the tube bundle to the air exhaust, and a plenum chamber for directing the airflow between the at least one fan and the tube bundle, the method comprising:
measuring a discharge fluid temperature representing a temperature associated with a cooled process fluid product discharged from the tube bundle;
in response to the discharge fluid temperature falling to a first temperature, reducing a fan speed of the at least one fan to reduce cooling of the tube bundle;
in response to the discharge fluid temperature falling to a second temperature lower than the first temperature, at least partially closing at least one of the air intake and the air exhaust to further reduce cooling of the tube bundle;
measuring a plenum chamber air temperature representing a temperature of air proximate the tube bundle; and
in response to the plenum chamber air temperature falling below a minimum plenum chamber air temperature threshold, causing heated air received from an air handling unit to be injected into the air cooled heat exchanger to displace at least some cold air from within the air cooled heat exchanger, to increase the temperature of the air proximate the tube bundle.

2. The method of claim 1 wherein the air handling unit is external to the air cooled heat exchanger and the heated air is received into the air cooled heat exchanger from at least one external conduit interconnecting the air handling unit and the air cooled heat exchanger.

3. The method of claim 2 further comprising injecting the heated air received from the at least one external conduit into the air cooled heat exchanger via at least one internal conduit in communication with the at least one external conduit and having at least one discharge opening for heated air injection.

4. The method of claim 2 wherein the air handling unit comprises a fuel burning furnace.

5. The method of claim 1 wherein causing heated air to be injected further comprises discharging the heated air at a discharge location proximate a fan ring associated with the at least one fan.

6. (canceled)

7. The method of claim 3 wherein the at least one internal conduit has a distal discharge portion having a longitudinal axis parallel to an axis of rotation of the at least one fan.

8. (canceled)

9. The method of claim 3 further comprising discharging the heated air through at least one nozzle in communication with the at least one internal conduit and configured to direct the heated air toward the tube bundle.

10. The method of claim 1 further comprising discharging the heated air proximate the tube bundle.

11. The method of claim 2 wherein the air handling unit comprises an industrial building heating system configured to produce heated air in a temperature range suitable for injection into buildings inhabited by humans.

12. The method of claim 11 wherein the air handling unit generates a heated air stream having a temperature of about 40 degrees C.

13. The method of claim 1 further comprising, in response to the plenum chamber air temperature falling below a recirculation activation plenum temperature threshold, causing air to be recirculated within the air cooled heat exchanger.

14. The method of claim 13 further comprising causing at least one internal recirculation louver to open to facilitate air recirculation within the air cooled heat exchanger.

15. The method of claim 13 further comprising, in response to the plenum chamber air temperature exceeding a recirculation deactivation plenum temperature threshold, ceasing internal recirculation of air within the air cooled heat exchanger.

16. The method of claim 1 further comprising switching to a backup power system in response to detection of a main power system outage.

17. The method of claim 16 wherein at least partially closing at least one of the air intake and the air exhaust further comprises actuating at least one set of louvers to close, the method further comprising using power from the backup power system to enable the at least one set of louvers to close.

18. The method of claim 16 further comprising using power from the backup power system to activate the air handling unit.

19. The method of claim 1 wherein measuring the discharge fluid temperature comprises measuring a fluid temperature associated with a header of an individual air cooled heat exchanger.

20. The method of claim 1 wherein measuring the discharge fluid temperature comprises measuring a fluid product temperature associated with a common header of a bank of air cooled heat exchangers.

21. The method of claim 1, wherein the air handling unit comprises a Heating Ventilation and Air Conditioning (HVAC) unit, the method further comprising causing the air handing unit to deliver cooled air for injection into the air cooled heat exchanger to supplement fan-based cooling in the air cooled heat exchanger.

22. The method of claim 1, wherein the air handling unit comprises an HVAC unit, the method further comprising causing the air handing unit to deliver cooled air for injection into the air cooled heat exchanger to supplement fan-based cooling in the air cooled heat exchanger in response to the plenum chamber air temperature exceeding a forced air cooling plenum air temperature threshold.

23. The method of claim 1 further comprising disabling the air handing unit from supplying heated air in response to the plenum chamber air temperature exceeding a maximum forced air heating temperature threshold.

24. The method of claim 1 further comprising measuring the ambient air temperature, wherein heated air from the air handling unit is injected into the air cooled heat exchanger only if the ambient temperature falls below a minimum permissible ambient air temperature threshold.

25. The method of claim 1 further comprising, in response to detecting a no flow condition for the process fluid, causing heated air to be injected from the air handling unit into the air cooled heat exchanger.

26. The method of claim 1 further comprising, in response to detecting a louver malfunction condition, causing heated air to be injected from the air handling unit into the air cooled heat exchanger if the ambient air temperature is below a minimum permissible ambient air temperature threshold.

27. The method of claim 1 further comprising, in response to the plenum chamber air temperature falling below the minimum plenum chamber air temperature threshold, turning off the at least one fan.

28. The method of claim 1 further comprising, in response to the plenum chamber air temperature falling below the minimum plenum chamber air temperature threshold, closing the air intake and the air exhaust.

29. The method of claim 1 further comprising conducting maintenance work within the air cooled heat exchanger unit without draining the tube bundle, notwithstanding that an ambient temperature outside the air cooled heat exchange is sufficiently cold to create a freezing risk for the process fluid.

30. A computer-readable medium storing instructions for directing a processor circuit to execute the method of claim 1.

31. (canceled)

32. An air cooled heat exchanger system comprising:
an air cooled heat exchanger comprising an air intake, an air exhaust, a tube bundle carrying a process fluid to be cooled and disposed between the air intake and the air exhaust, at least one fan operable to create an airflow from the air intake through the tube bundle to the air exhaust, and a plenum chamber for directing the airflow between the at least one fan and the tube bundle, the air cooled heat exchanger having an external air opening and an internal conduit in communication with the external air opening and operable to inject heated air received from the external air opening into the air cooled heat exchanger to displace at least some cold air therefrom;
a furnace operable to generate a heated air stream, the furnace being located externally to the air cooled heat exchanger, the furnace output being in communication with the external air opening; and
a control system operably configured to:
reduce a fan speed associated with the at least one fan of the air cooled heat exchanger in response to receiving a sensor measurement signal indicating that at least one discharge fluid temperature has fallen below a first temperature;
close the external louvers of the air cooled heat exchanger in response to receiving a sensor measurement signal indicating that the at least one discharge fluid temperature has fallen below a second temperature, lower than the first temperature; and
enable the air furnace to produce heated air for injection into the air cooled heat exchanger to displace at least some cold air from the air cooled heat exchanger and to impart heat to at least some cooler air proximate the tube bundle, in response to receiving a sensor measurement signal indicating that the plenum temperature has fallen below a minimum plenum air temperature threshold.

33. An air cooled heat exchanger apparatus for facilitating temperature control of a process fluid, the apparatus comprising:
an enclosure comprising a selectively sealable air intake and a selectively sealable air exhaust, the air intake comprising a set of air intake louvers, the air exhaust comprising a set of air exhaust louvers;
at least one fan operable to cause a cooling airflow to flow along an airflow path from the air intake to the air exhaust; and
a tube bundle comprising a plurality of spaced apart tubes operable to carry the process fluid, the tube bundle being disposed in the airflow path between the air intake and the air exhaust;
wherein the enclosure further comprises a forced air injection intake configured to receive a forced air stream from a location external to the enclosure to pressurize the enclosure when the air intake louvers and the air exhaust louvers are sealed, whereby at least some of the air within the enclosure is displaced to a location external to the enclosure.

34. The apparatus of claim 33 further comprising at least one internal conduit in communication with the forced air injection intake, the at least one internal conduit having a distal discharge portion operable to discharge the forced air stream in at least one discharge location within the enclosure.

35. The apparatus of claim 34 wherein the distal discharge portion is configured to discharge the forced air stream proximate a fan ring associated with the at least one fan.

36. The apparatus of claim 34 wherein the distal discharge portion is configured to discharge the forced air stream proximate the tube bundle.

37. The apparatus of claim 34 wherein the distal discharge portion has a longitudinal axis parallel to an axis of rotation of the at least one fan.

38. (canceled)

39. (canceled)

40. A method of temperature control of a process fluid in a tube bundle of an air cooled heat exchanger (ACHE), the method comprising:
(a) reducing a fan speed and at least partially closing an air intake and an air exhaust of the ACHE in response to a discharge fluid temperature falling below a first temperature threshold, to reduce a rate of cooling of the process fluid in the tube bundle; and
(b) causing heated air from an external air handling unit to be injected into the ACHE to displace cold air therefrom to further reduce the rate of cooling of the process fluid in the tube bundle, in response to a plenum chamber air temperature falling below a second temperature threshold.

41. The method of claim 40 further comprising, causing cooled air received from the external air handling unit to be injected into the ACHE to displace at least some heated air therefrom to induce cooling of fluid in the tube bundle, in response to the plenum chamber air temperature exceeding a forced air cooling temperature threshold.
